(19) United States
(12) Patent Application Publication
(10) Pub. No.: US 2026/0140385 A1
(43) Pub. Date: May 21, 2026

(54) MOUNTING APPARATUS FOR MOUNTING VIDEO DISPLAY APPARATUS ON HEAD OF USER, AND VIDEO DISPLAY UNIT

(71) Applicant: CANON KABUSHIKI KAISHA, Tokyo (JP)

(72) Inventor: Toshiharu KAWAI, Kanagawa (JP)

(21) Appl. No.: 19/386,077

(22) Filed: Nov. 11, 2025

(30) Foreign Application Priority Data
Nov. 19, 2024 (JP) 2024-201785

(51) Int. Cl. G02B 27/01; G02C 5/20

(52) U.S. Cl. CPC G02B 27/0176; G02C 5/20

(57) ABSTRACT

A mounting apparatus includes an installation portion configured to allow a video display apparatus to be installed thereon; and a pair of side portions extending in directions bent from a left end and a right end of the installation portion, wherein each of the side portions includes an arm member that is movable in a longitudinal direction, and wherein each of the arm members is movable in a direction different from the longitudinal direction after being extendably moved in the longitudinal direction.

### BACKGROUND

### Field of the Technology

The present disclosure relates to a mounting apparatus, and, in particular, to a mounting apparatus for mounting a video display apparatus on the head of a user, and to a video display unit.

### Description of the Related Art

In recent years, there have been used head-mounted displays (HMDs) configured to be mounted on the head of a user to display a video image in front of the user's eyes. The HMDs are used as an apparatus capable of providing experiences of virtual reality (VR) and mixed reality (MR) for reasons including allowing the user to easily view visual content in a manner equivalent to viewing on a large screen and facilitating stereoscopic viewing.

Examples of the HMDs include an HMD having a ring-shaped head-mounting unit that is worn around a user's head as described in Japanese U.S. Pat. No. 3,576,985, and an HMD having a head-mounting unit that is held by clamping a user's temporal regions as described in Japanese Patent Laid-Open No. 2021-71603. In the HMD described in Japanese U.S. Pat. No. 3,576,985, the user puts the ring portion on by bringing the portion down from above the head, which requires the user to make position adjustment after roughly positioning the HMD without viewing the display image. This may take more time to adjust the position. The HMD described in Japanese Patent Laid-Open No. 2021-71603 has an open shape at the back part of the head unlike the ring-shaped head-mounting unit, allowing the user to mount that HMD by bringing the HMD closer to the user's head from the front while viewing the display image to perform positioning. Thus, the HMD described in Japanese Patent Laid-Open No. 2021-71603 does not require a long time for positioning.

However, a heavy HMD imposes a significant burden on the ears and the nose, potentially making it impossible to mount or causing discomfort. The configuration that holds the temporal regions of the head, like the HMD described in Japanese Patent Laid-Open No. 2021-71603, also leads to increase in clamping force applied to the head to exert holding force sufficient to support the video display apparatus in front of the eyes away from the temporal regions of the head. This also makes it impossible to mount the HMD or cause discomfort. Strong clamping force applied to the head leads to increase in force required to open arm members of the head-mounting unit when the user mounts the HMD, resulting in reduced usability.

### SUMMARY

In view of the above-described issues, the present disclosure is directed to providing a mounting apparatus that can shorten time used for position adjustment, eliminate unwearability and discomfort when mounted, and facilitate mounting and removal with light force, which will increase usability.

According to some embodiments of the present disclosure, a mounting apparatus includes an installation portion configured to allow a video display apparatus to be installed thereon; and a pair of side portions extending in directions bent from a left end and a right end of the installation portion, wherein each of the side portions includes an arm member that is movable in a longitudinal direction, and wherein each of the arm members is movable in a direction different from the longitudinal direction after being extendably moved in the longitudinal direction.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of a video display apparatus as a video display unit of a head-mounted display (HMD) according to a first embodiment.

FIG. 2A is a back view of the video display apparatus when an inter-pupillary distance is shortest.

FIG. 2B is a back view of the video display apparatus when the inter-pupillary distance is longest.

FIG. 3 is a perspective view of the back surface of the video display apparatus.

FIG. 4 is a perspective view of the HMD configured so that the video display apparatus can be mounted on the head of a user according to the first embodiment.

FIG. 5 is a perspective view of a head-mounting unit, which is a mounting apparatus according to the first embodiment, provided with the video display apparatus of the HMD.

FIG. 6A is a top view for illustrating a procedure 1 in mounting the head-mounting unit on the head.

FIG. 6B is a top view for illustrating a procedure 2 in mounting the head-mounting unit on the head.

FIG. 6C is a top view for illustrating a procedure 3 in mounting the head-mounting unit on the head.

FIG. 6D is a top view for illustrating a procedure 4 in mounting the head-mounting unit on the head.

FIG. 7A is a perspective view of an arm member in a closed state.

FIG. 7B is a perspective view of the arm member in an opened state.

FIG. 8A is a top view of the arm member in the closed state.

FIG. 8B is a top view of the arm member in the opened state.

FIG. 9A is a top view of an HMD according to a comparative example to the first embodiment with an arm member closed.

FIG. 9B is a top view of the HMD according to the comparative example to the first embodiment with the arm member opened.

FIG. 10 is a side view of the HMD according to the first embodiment as viewed from the right.

FIG. 11 is a side view of a state in which the HMD according to the first embodiment is used as a hand-held display (HHD) with the HHD viewed from the right.

FIG. 12 is a perspective view of the state in which the HMD according to the first embodiment is used as the HHD with the HHD viewed from the right.

FIG. 13A is a perspective view of an HMD according to a modification of the first embodiment with a right-side arm member thereof closed.

FIG. 13B is a perspective view of the HMD according to the modification of the first embodiment with the right-side arm member thereof opened.

FIG. 14 is a perspective view of an HMD according to a second embodiment in a mounted state.

FIG. 15 is a perspective view of a head-mounting unit provided with the video display apparatus of the HMD according to the second embodiment.

FIG. 16A is a side view for illustrating a procedure 1 when the head-mounting unit is mounted on the head with the head-mounting unit viewed from the right.

FIG. 16B is a side view for illustrating a procedure 2 when the head-mounting unit is mounted on the head with the head-mounting unit viewed from the right.

FIG. 16C is a side view for illustrating a procedure 3 when the head-mounting unit is mounted on the head with the head-mounting unit viewed from the right.

### DESCRIPTION OF THE EMBODIMENTS

### Basic Configuration of Mounting Apparatus According to Present Disclosure

To disclose various exemplary embodiments, features, aspects of the present disclosure in detail, the basic configuration of a mounting apparatus according to the present disclosure will now be described.

The mounting apparatus according to the present disclosure includes an installation portion where a video display apparatus can be installed, and a pair of side portions extending in directions bent from a left end and a right end of the installation portion, respectively. The side portions each include an arm member movable in a longitudinal direction, and the arm members are movable in different directions from the longitudinal direction after being extendably moved in the longitudinal direction of the side portions. In this manner, through the movement of the side portions in the longitudinal direction, the arm members can be positioned in a first arrangement in which the arm members linearly extend in the longitudinal direction, and in a second arrangement in which the arm members are movable in the different directions from the longitudinal direction. The mounting apparatus configured as above according to the present disclosure is applied to, for example, a mounting apparatus that is mounted on the head of a user. When the user mounts or removes the mounting apparatus according to the present disclosure, by changing the mounting apparatus from the first arrangement to the second arrangement, the user can move the arm members away from each other to easily put the user's head between the arm members. The user may not need to keep the mounting apparatus in a state that the arm members are opened against clamping force applied when the mounting apparatus is mounted on the head, thereby increasing the operability.

As the second arrangement of the arm members, for example, two types of embodiments are considered in which the arm members are each movable outward with respect to the mounting unit after being extendably moved in the longitudinal direction of the side portions. In one embodiment, the arm members are movable in a leftward or rightward opening direction after being extendably moved in the longitudinal direction of the side portions. The embodiment will be described in detail as a first embodiment. In the other embodiment, the arm members are movable in an upward opening direction after being extendably moved in the longitudinal direction of the side portions, and the other embodiment will be described in detail as a second embodiment.

### Specific Descriptions of Some Embodiments

Some embodiments of the present disclosure will be described in detail with reference to the drawings. The following embodiments do not limit the disclosure according to the claims. While a plurality of features is described in the embodiments, not all of the plurality of features is necessarily essential and the plurality of features may be combined in any suitable manner. Further, like reference numerals refer to like components in the drawings, and redundant descriptions will be omitted. Details of dimensions and structures described in each of the embodiments are not limited to those described herein and illustrated in the drawings.

### First Embodiment

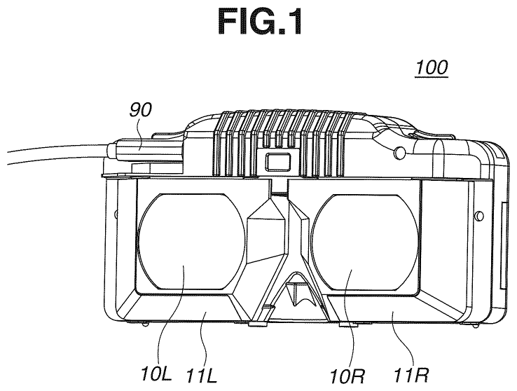

FIG. 1 is a perspective view of a video display apparatus 100 as a video display unit of a head-mounted display (HMD) according to a first embodiment.

The video display apparatus 100 includes lenses 10L and 10R, and a user sees a video image by looking into the lenses 10L and 10R. The lenses 10L and 10R are, for example, prisms or lenses that guide light or enlarge images on a display unit (not illustrated), such as a liquid crystal display (LCD) or an organic light emitting diode (OLED) included in the video display apparatus 100.

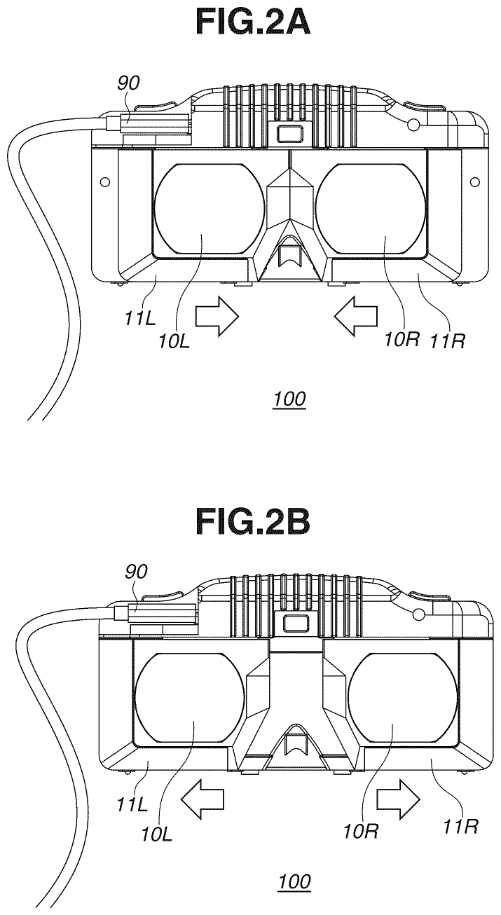

The video display apparatus 100 includes hoods 11L and 11R around the lenses 10L and 10R, respectively. The video display apparatus 100 is configured to allow the user to adjust the positions of the lenses 10L and 10R to the left and the right based on the user's inter-pupillary distance by operating the hoods 11L and 11R as illustrated in FIGS. 2A and 2B.

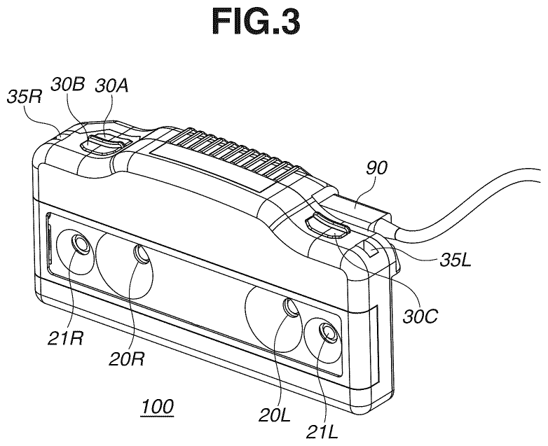

FIG. 3 is a perspective view of the back surface of the video display apparatus 100.

The video display apparatus 100 includes imaging cameras 20L and 20R and alignment cameras 21L and 21R. The imaging cameras 20L and 20R are stereo cameras for acquiring surrounding real images that are displayed to the user via the lenses 10L and 10R. The alignment cameras 21L and 21R are stereo cameras for acquiring the position and the orientation of the video display apparatus 100 from the acquired images using markers, feature points, such as edges of objects, and the like.

In the present embodiment, the imaging cameras 20L and 20R and the alignment cameras 21L and 21R are provided as individual components. The alignment cameras 21L and 21R are monochrome cameras configured to achieve high-accuracy and fault-tolerant alignment using a wide angle of view, a high shutter speed, and a long baseline length. Display images and alignment information can also be acquired by the imaging cameras 20L and 20R alone. Further, the alignment cameras 21L and 21R may be replaced with, for example, distance sensors using ultrasonic waves, infrared light, or the like.

The video display apparatus 100 exchanges positional information and images with an external personal computer (PC) or a controller (not illustrated) via a cable 90 to generate display images in which, for example, computer graphics (CG) are superimposed on real images. The video display apparatus 100 is configured to display display images, allowing the user to see the display images via the lenses 10L and 10R. Further, the video display apparatus 100 includes operation buttons 30A, 30B, and 30C that allow the user to perform instruction operations, power source operations, and the like.

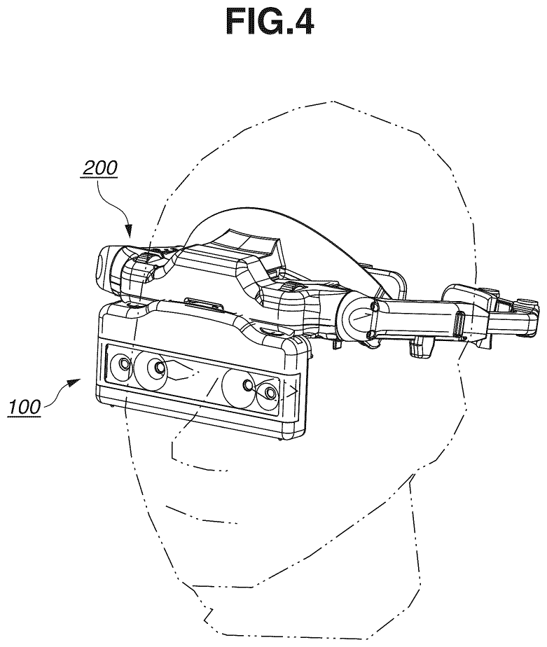

FIG. 4 is a perspective view of a head-mounted display (HMD) configured so that the video display apparatus 100 can be mounted on the head of the user according to the present embodiment. The HMD allows the user to see video images in a hands-free manner using a head-mounting unit 200, which is the mounting apparatus.

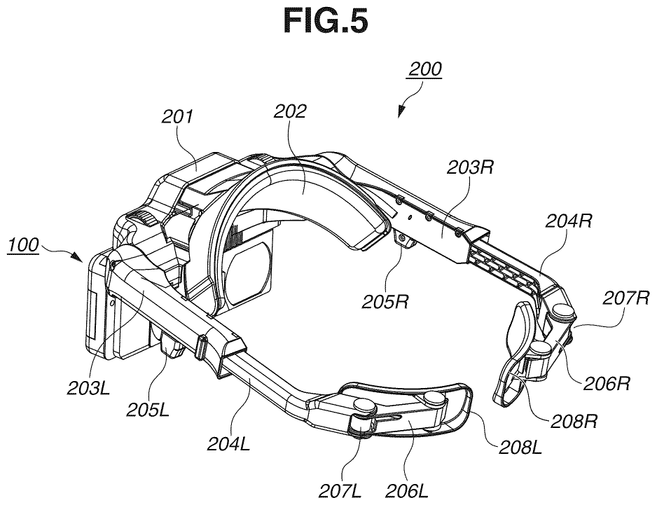

FIG. 5 is a perspective view of the head-mounting unit 200, which is the mounting apparatus according to the present embodiment, provided with the video display apparatus 100 of the HMD.

The head-mounting unit 200 includes a front frame 201 and a pair of side portions 203L and 203R. The front frame 201 is the installation portion configured to allow the video display apparatus 100 to be installed thereon, and includes a front pad 202 configured to come into contact with the user's forehead. The pair of side portions 203L and 203R extends in the direction bent from the left end and the right end of the front frame 201, respectively, toward the back of the head.

The side portions 203L and 203R include arm members 204L and 204R movable in the longitudinal direction, and operation levers 205L and 205R as operation members provided at the front ends of the arm members 204L and 204R, respectively. The side portions 203L and 203R further include pressing arms 206L and 206R, and rear pads 208L and 208R. The pressing arms 206L and 206R are pivotally supported at the rear ends of the arm members 204L and 204R, respectively, with pressing springs 207L and 207R provided at the rear ends of the arm members. The rear pads 208L and 208R are abutment members for the back of the user's head, and are pivotally supported on the pressing arms 206L and 206R, respectively. The rear pads 208L and 208R are configured to come into contact with the back of the user's head along the contour of the back of the user's head using the pressing springs 207L and 207R to press the back of the user's head toward the front frame 201.

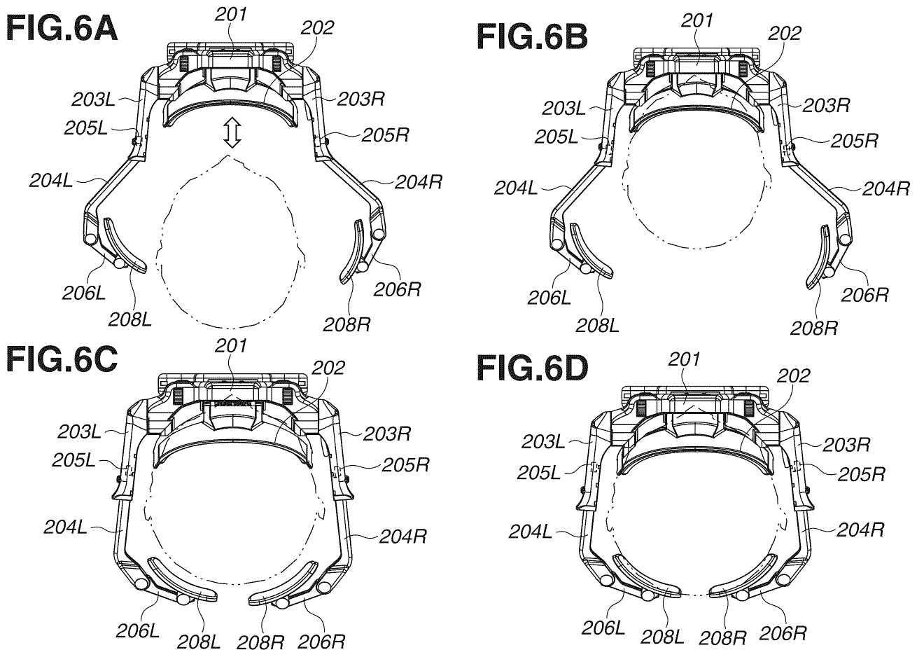

FIGS. 6A to 6D are top views for illustrating procedures 1 to 4 in mounting the head-mounting unit 200 on the head. FIG. 6A illustrates the head-mounting unit 200 with the arm members 204L and 204R opened and the front pad 202 away from the user's forehead. FIG. 6B illustrates the head-mounting unit 200 with the arm members 204L and 204R opened and the front pad 202 in contact with the user's forehead. FIG. 6C illustrates the head-mounting unit 200 with the arm members 204L and 204R closed and the rear pads 208L and 208R away from the back of the user's head. FIG. 6D illustrates the head-mounting unit 200 with the arm members 204L and 204R closed and the rear pads 208L and 208R in contact with the back of the user's head.

First, as illustrated in FIG. 6A, by moving the operation levers 205L and 205R backward, the arm members 204L and 204R are extendably moved while sliding backward, i.e., in the longitudinal direction of the side portions 203L and 203R. Upon the ends of the arm members 204L and 204R being moved to the back ends of the side portions 203L and 203R, the ends of the arm members 204L and 204R become movable in different directions from the longitudinal direction of the side portions 203L and 203R, respectively. Specifically, in the present embodiment, the arm members 204L and 204R become movable outward (in a leftward opening direction for the side portion 203L and in a rightward opening direction for the side portion 203R) with respect to the front frame 201. The arm members 204L and 204R are pivoted toward the outside of the head with the ends set as rotational axes to be brought into an opened state. In this manner, with the arm members 204L and 204R in the opened state, the head-mounting unit 200 can be brought close to the user's head from the front.

Next, as illustrated in FIG. 6B, the head-mounting unit 200 is moved closer to the user's forehead to bring the front pad 202 into contact with the user's forehead.

As illustrated in FIG. 6C, the operation levers 205L and 205R are then moved toward the front with the front pad 202 in contact with the forehead. At this time, the arm members 204L and 204R are brought into a closed state along the back of the head, and the ends of the arm members 204L and 204R are received in the side portions 203L and 203R, respectively, to be moved in a contraction direction. However, the rear pads 208L and 208R do not come in contact with the back of the head at this point of time.

Subsequently, as illustrated in FIG. 6D, by moving the operation levers 205L and 205R further forward, the rear pads 208L and 208R contact the back of the head to press the back of the head via the action of the pressing springs 207L and 207R. In this manner, the head-mounting unit 200 is fixed to the user's head.

In the head-mounting unit 200, the clamping pressure on the user's head can be adjusted as desired by appropriately adjusting the positions of the operation levers 205L and 205R based on the user's head size or the user's preference.

The head-mounting unit 200 can be removed from the user's head by performing operations in the reverse order of the above-described operation procedures (in the order of FIGS. 6D, 6C, 6B, and 6A). By moving the operation levers 205L and 205R backward, the arm members 204L and 204R also move backward, resulting in the state where the arm members 204L and 204R are opened outward with respect to the user's head, which allows the head-mounting unit 200 to be removed from the user's head.

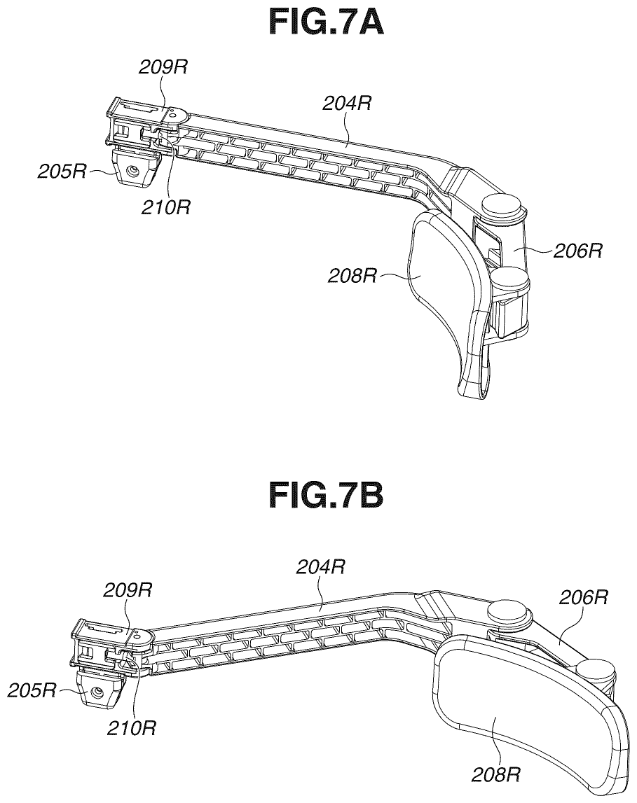

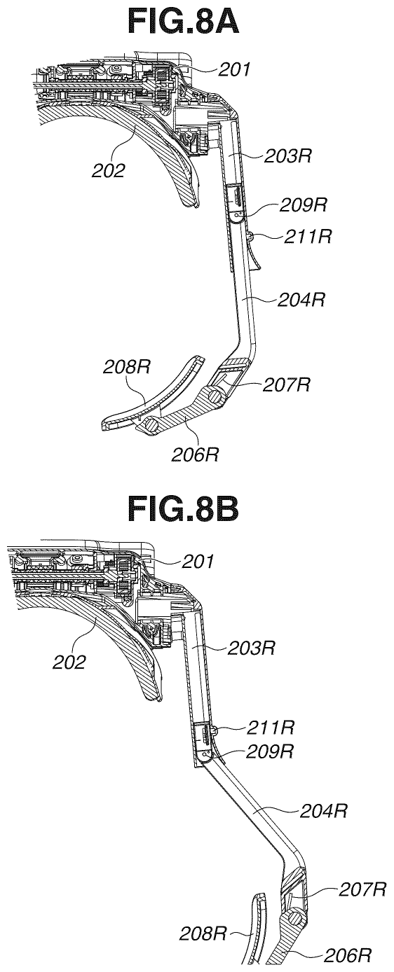

FIGS. 7A and 7B are each a perspective view of one specific configuration of the arm member 204R. FIGS. 8A and 8B are each a top view of the arm member 204R. FIGS. 7A and 8A each illustrate the arm member 204R in the closed state, and FIGS. 7B and 8B each illustrate the arm member 204R in the opened state. The arm member 204L has a horizontally symmetrical configuration equivalent to that of the arm member 204R.

The side portion 203R includes an inner piece 209R, which is a front member provided integrally with the operation lever 205R, at the front end of the arm member 204R. When the operation lever 205R is moved forward, the arm member 204R is brought into a state of being guided by the side portion 203R with the front end of the arm member 204R received in the side portion 203R as illustrated in FIGS. 7A and 8A. The arm member 204R is pivotally supported with respect to the inner piece 209R. At this time, the arm member 204R is closed, and is elastically biased outward with respect to the front frame 201 by a spring 210R as a biasing member.

When the operation lever 205R is moved backward, the inner piece 209R is moved to the back end of the side portion 203R, and the front end of the arm member 204R is detached from the guide structure of the side portion 203R to be exposed outward from inside the side portion 203R as illustrated in FIGS. 7B and 8B. At this time, as the front end of the arm member 204R is disengaged from the guide structure of the side portion 203R, the constraint against outward rotation is removed; accordingly, the spring 210R urges the arm member 204R outward with respect to the front frame 201, and the arm member 204R pivots into the opened state.

Then, by operating the operation lever 205R to move forward, the inner piece 209R and the arm member 204R contractively move to the front, and then the front end of the arm member 204R is received in the side portion 203R.

At this time, the arm member 204R returns into the state of being guided by the side portion 203R as illustrated in FIGS. 7A and 8A.

The springs 210L and 210R are provided at the ends of the arm members 204L and 204R, respectively, to apply biasing force to the arm members 204L and 204R in the present embodiment. However, the springs 210L and 210R may be omitted to reduce the number of components to simplify the configuration of the HMD. In this case, the closing operations of the arm members 204L and 204R are performed automatically by moving the operation levers 205L and 205R forward similarly to the above description. In the opening operations of the arm members 204L and 204R, moving the operation levers 205L and 205R backward brings the arm members 204L and 204R into an openable state. At this time, the user can open the arm members 204L and 204R with light force without resisting the biasing forces, and remove the head-mounting unit 200 directly from the user's head. This does not significantly reduce usability.

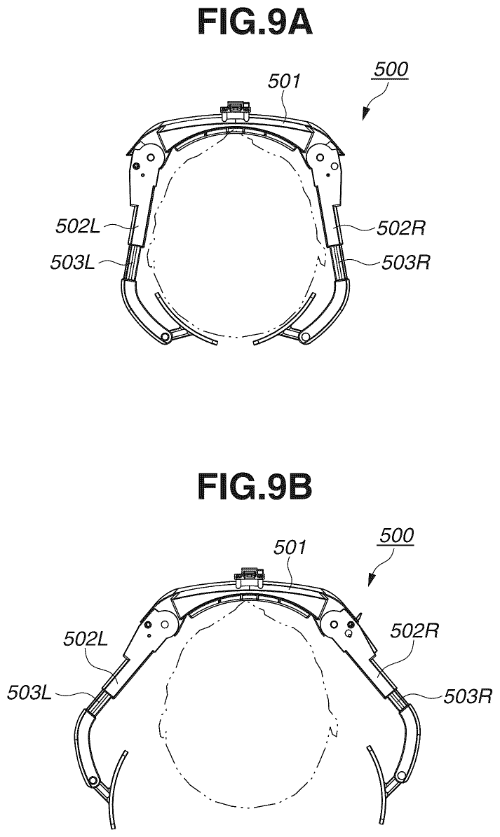

FIGS. 9A and 9B are each a top view of an HMD according to a comparative example to the present embodiment. FIG. 9A illustrates the HMD with arm members closed, and FIG. 9B illustrates the HMD with the arm members opened.

In the HMD according to the comparative example, a head-mounting unit 500 includes a front frame 501 on which a video display apparatus is installed, and a pair of side portions 502L and 502R. The side portions 502L and 502R include arm members 503L and 503R movable in the longitudinal direction. The side portions 502L and 502R are configured to be pivotable while being elastically biased inward with respect to the front frame 501 at the left end and the right end of the front frame 501.

The HMD according to the comparative example requires the user to keep the arm members 503L and 503R in an opened state against the biasing force that urges inward with respect to the front frame 501 when mounting or removing the head-mounting unit 500. In this case, clamping force on the back of the head is exerted by a torque around the arm's pivot on the front side, and thus, the clamping force tends to be applied in directions more toward the left and right sides of the head. Thus, in order to exert the clamping force between the forehead and the head-mounting unit 500, it is necessary to increase the torque around the arm's pivot, which results in increased force required to open the arm members 503L and 503R when the user attempts to mount the head-mounting unit 500 from the front, leading to reduction in usability.

On the other hand, in the case of the HMD according to the present embodiment, the arm members 204L and 204R are brought into the state of being opened outward with respect to the longitudinal direction of the side portions 203L and 203R when the head-mounting unit 200 is mounted or removed. Thus, unlike conventional HMDs, it is not necessary for the user to keep the arm members in an opened state against the clamping force while the head-mounting unit 200 is being mounted on the head, improving the operability of the HMD.

Further, a conventional HMD having a ring-shaped head-mounting unit that wraps around the head of the user includes, for example, a dial for tightening the head-mounting unit on the head, and a button for releasing the tightened state. Thus, it is necessary for the user to operate a plurality of mechanisms, such as the dial and the button, when mounting or removing the head-mounting unit.

On the other hand, the HMD according to the present embodiment allows the user to perform a series of operations of moving and opening the arm members 204L and 204R to mount and remove the head-mounting unit 200 with a single operation mechanism using the operation levers 205L and 205R. In other words, for the HMD according to the present embodiment, the user holds the side portions 203L and 203R and operates the operation levers 205L and 205R using the user's thumbs or the like without moving the user's hands off to mount and remove the head-mounting unit 200. In the HMD according to the present embodiment, a mechanism, for example, that locks positions of the operation levers 205L and 205R relative to the arm members 204L and 204R is unnecessary, allowing the user to perform operations of mounting and removing the head-mounting unit 200 and of increasing and decreasing the pressure only by moving the operation levers 205L and 205R forward and backward. This can shorten time used for mounting and removal, and positioning the head-mounting unit 200, achieving excellent operability.

Referring back to FIG. 8A, the position retention of the arm member 204R when the HMD is mounted on the head will be described. The position of the arm member 204L can also be kept in the same manner as that of the arm member 204R.

The head-mounting unit 200 includes a support member 211R, which is made of, for example, rubber having a higher friction coefficient than that of the side portion 203R as a raw material, disposed at the back end of the side portion 203R, i.e., the surface external as viewed from the user's head. When the rear pad 208R contacts the back of the user's head to be pressed, its reaction force causes the arm member 204R to come into contact with the support member 211R. Here, it is on the assumption that the axial pivot of the arm member 204R with the inner piece 209R serves as the fulcrum, and the point that receives forces from the rear pad 208R and the pressing spring 207R via the pressing arm 206R at the back end of the arm member 204R serves as the effort point. The contact point between the arm member 204R and the support member 211R serves as the load point, and the forces in the directions toward the sides of the head received at the effort point act as greater contact pressure on the support member 211R at the load point by the principle of the lever. At this time, the frictional force generated between the arm member 204R and the support member 211R functions as the brake force that prevents forward and rearward movement of the arm member 204R. Thus, without the need to provide a stopper mechanism to prevent forward and rearward movement of the arm member 204R, the force that attempts to move the arm member 204R rearward as the reaction force generated when the rear pad 208R is in contact with the head can be counteracted, which maintains the position of the rear pad 208.

When the user operates the operation lever 205R to move the operation lever 205R forward and backward, force is applied in the movement direction of the arm member 204R. Thus, the arm member 204R can be smoothly moved forward and backward without increase in the contact pressure on the support member 211R or the brake force. Further, unlike the case where a stopper mechanism using, for example, a latch hook mechanism is provided, movement can be performed without operating a stepless position holding mechanism or a release mechanism, which further increases the usability.

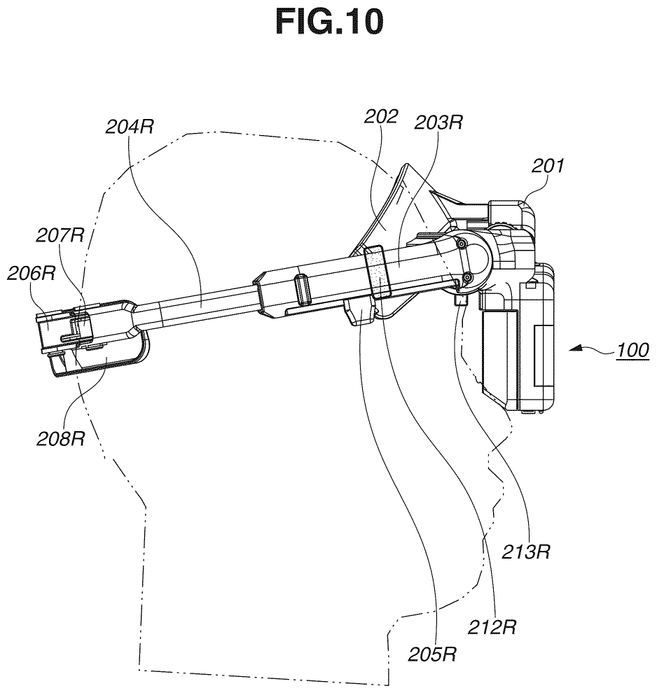

FIG. 10 is a side view of the HMD according to the present embodiment as viewed from the right.

In the example illustrated in FIG. 10, a stopper 212R, a member for restricting the operation lever 205R within a certain movement range, is fixedly disposed on the side portion 203R, and the stopper 212R stops the operation lever 205R so as to prevent the operation lever 205R from moving forward beyond the position at which the stopper 212R is fixed. The stopper 212R configured to be detachably attachable to the side portion 203R is movable to and fixable at a predetermined position of the side portion 203R with the stopper 212R attached to the side portion 203R.

When using the HMD according to the present embodiment, it is conceivable that the user initially determines the position of the operation lever 205R to adjust to a desired clamping pressure, and then fix the stopper 212R at that position. As a result, in subsequent operations, the same clamping pressure can be easily produced simply by moving the operation lever 205R until the operation lever 205R abuts against the stopper 212R, improving the usability.

While the configuration on the right side of the HMD has been described, the left side has the same configuration as that on the right side, and the installation positions of the stoppers 212L and 212R can be adjusted independently so as to achieve a desired contact pressure on each side. Here, the left and right stoppers 212L and 212R can be configured in such a manner that the installation positions are linked using, for example, a wire via the front frame 201. In this case, for example, performing the operation for adjusting the installation position of the stopper 212L, which is one of the stoppers, causes the other stopper 212R to be simultaneously adjusted to, for example, an installation position horizontally symmetrical to the stopper 212L.

In this manner, by performing an adjustment operation only on the installation position of the stopper on one side, the adjustment operation can be completed at once, eliminating the effort for repeated adjustments to shorten time for the adjustment.

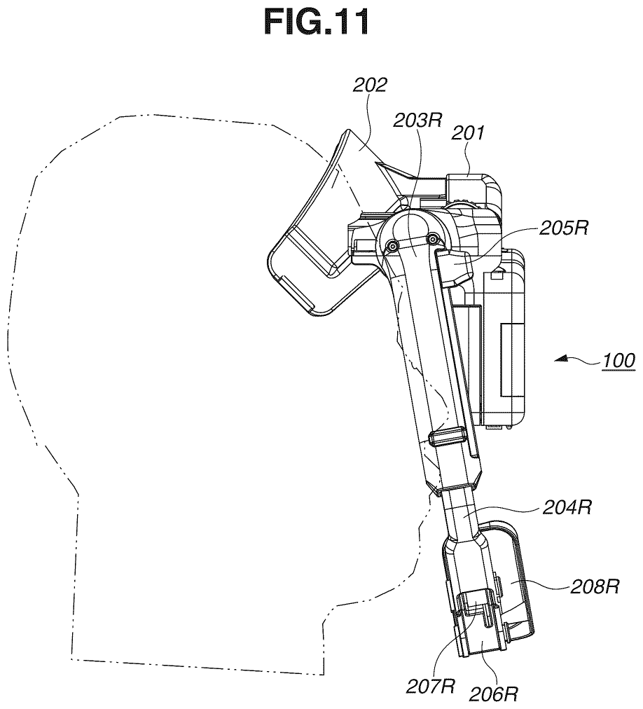

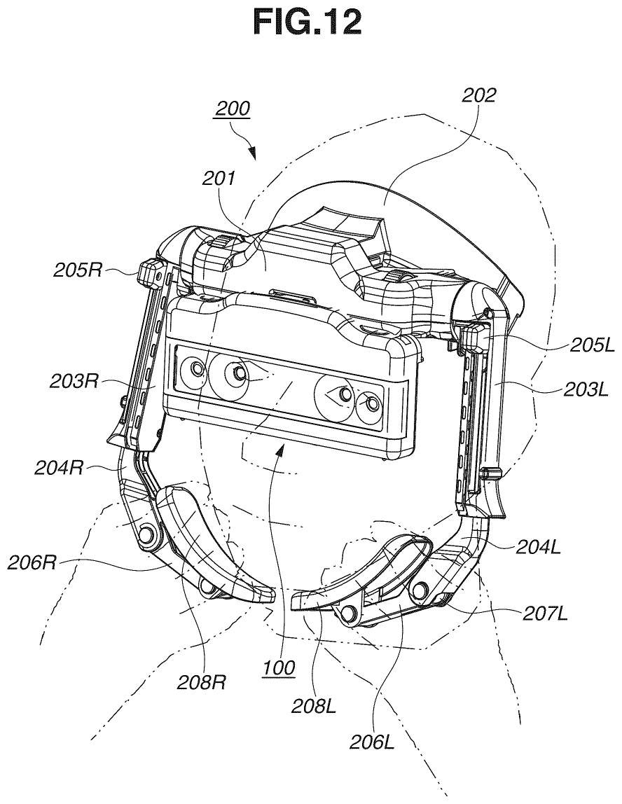

FIG. 11 is a side view of a state in which a hand-held display (HHD) viewed from the right, illustrating when the HMD according to the present embodiment is used as the HHD. FIG. 12 is a perspective view for illustrating when the HMD according to the present embodiment is used as the HHD.

The side portions 203L and 203R are pivoted in directions toward the lower front side together with the arm members 204L and 204R as illustrated in FIGS. 11 and 12 by operating arm stopper levers 213L and 213R (FIG. 10), respectively, provided on the front frame 201. This makes it possible to change the HMD according to the present embodiment into an HHD form.

In the HHD form illustrated in FIGS. 11 and 12, the user can use the HMD according to the present embodiment as the HHD by gripping the side portions 203L and 203R or the arm members 204L and 204R. The change into the HHD form also allows the user to easily see video images while saving the user's time and effort to mount the HMD, for example, when the user performs a quick view that does not involve mounting the HMD on the user's head, or when the HMD is used by a user who is not comfortable with head mounting.

The side portions 203L and 203R and the arm members 204L and 204R are rigid sufficient to withstand the reaction force to the clamping force that is received from the rear pads 208L and 208R when the HMD is mounted on the head, unlike the ring-shaped head-mounting unit wrapped around the head of the user. Thus, the side portions 203L and 203R and the arm members 204L and 204R are sufficient in strength for hand-held handles of the HHD.

In the HHD form illustrated in FIGS. 11 and 12, the arm members 204L and 204R are positioned in the state of being maximumly moved forward, but the positions of the arm members 204L and 204R are not limited thereto. For example, the positions of the arm members 204L and 204R can also be fixed at desired lengths by using the above-described stoppers 212L and 212R.

In the above-described manner, according to the present embodiment, the HMD provides increased usability by shortening time used for position adjustment of the side portions 203L and 203R, eliminating unwearability and discomfort when mounted, and facilitating wearing and removal with light force.

### Modification

A modification will now be described of the HMD according to the present embodiment.

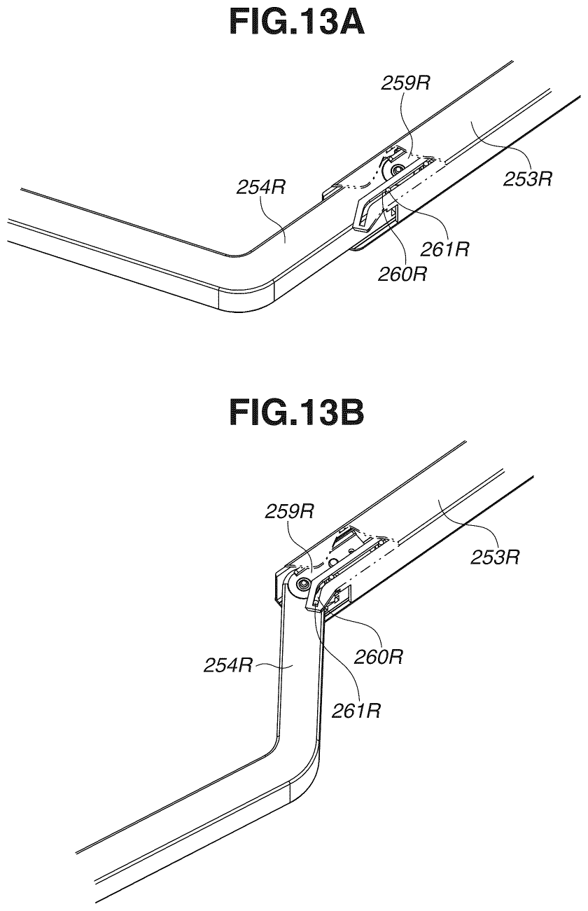

FIGS. 13A and 13B are each perspective views of a right-side arm member 254R in the HMD according to the modification. FIG. 13A illustrates the arm member 254R in a closed state, and FIG. 13B illustrates the arm member 254R in an opened state. A left-side arm member 254L has a horizontally symmetrical configuration equivalent to that of the arm member 254R.

The HMD according to the modification has a cam groove 260R, which is bent outward with respect to the front frame at the backmost end portion, formed at the back end of the side portion 253R. The arm member 254R does not include a spring 210R like that in the present embodiment at the front end, and has a shape bent inward with respect to the front frame. A guide pin 261R, which is movably engaged with the cam groove 260R, is provided at the front end of the arm member 254R. An inner piece 259R is provided integrally with a not-illustrated operation lever.

In this HMD, the guide pin 261R is engaged with a front portion of the cam groove 260R that extends in the longitudinal direction of the side portion 253R with the front end of the arm member 254R received in the side portion 253R as illustrated in FIG. 13A. When the operation lever is moved forward in this state, the guide pin 261R is guided by the cam groove 260R, and the arm member 254R is moved in the longitudinal direction of the side portion 253R while being kept in the closed state.

In this HMD, the operation lever is moved backward as illustrated in FIG. 13B. At this time, the guide pin 261R is guided by the outward bent portion at the backmost end portion of the cam groove 260R, and then the arm member 254R is opened outward with respect to the front frame.

In the HMD according to the modification, the arm members 254L and 254R are brought into a state of being opened outward with respect to the longitudinal direction of the side portions 253L and 253R while the head-mounting unit is mounted or removed. Thus, unlike conventional HMDs, it is not necessary for the user to keep the arm members in an opened state against the clamping force while the head-mounting unit 200 is being mounted on the head, improving the operability of the HMD.

Further, the HMD according to the modification allows the user to perform a series of operations of moving and opening the arm members 254L and 254R for mounting and removing the HMD by using a single operation mechanism with the operation levers. In other words, for the HMD according to the present embodiment, the user grips the side portions 253L and 253R and operates the operation levers using the user's thumbs or the like without moving the user's hands off to mount and remove the head-mounting unit. The HMD according to the present embodiment, a mechanism, for example, that locks the positions of the operation levers relative to the arm members 204L and 204R is unnecessary, allowing the user to perform operations of mounting and removing the head-mounting unit, and increasing and decreasing the pressure only by moving the operation levers forward and backward. This can shorten time used for mounting and removal, and positioning the head-mounting unit, achieving excellent operability.

In the above-described manner, according to the modification, the HMD provides increased usability by shortening time used for a position adjustment of the side portions 253L and 253R, eliminating unwearability and discomfort when mounted, and facilitating mounting and removal with light force.

### Second Embodiment

A video display apparatus 100 according to the second embodiment has the same configuration as that of the video display apparatus 100 according to the first embodiment.

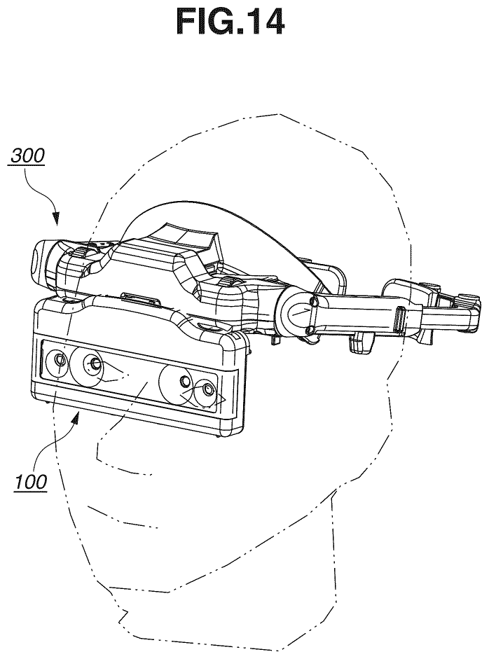

FIG. 14 is a perspective view of an HMD according to the present embodiment in a mounted state. The HMD allows the user to see video images in a hands-free manner using a head-mounting unit 300.

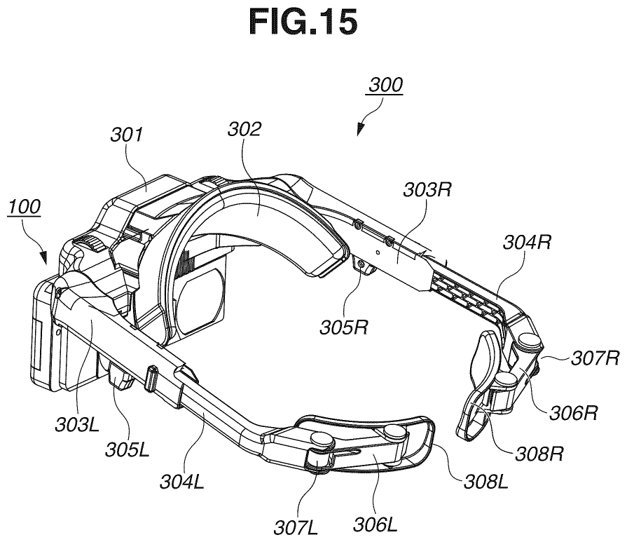

FIG. 15 is a perspective view of the head-mounting unit 300 provided with the video display apparatus 100 of the HMD according to the present embodiment.

The head-mounting unit 300 includes a front frame 301 and a pair of side portions 303L and 303R. The front frame 301 is the installation portion where the video display apparatus 100 is installed, and includes a front pad 302 configured to come in contact with the user's forehead. The pair of side portions 303L and 303R extends in directions bent from the left end and the right end of the front frame 301, respectively, toward the back of the head.

The side portions 303L and 303R include arm members 304L and 304R movable in the longitudinal direction, and operation levers 305L and 305R provided at the front ends of the arm members 304L and 304R, respectively. The side portions 303L and 303R further include pressing arms 306L and 306R, and rear pads 308L and 308R. The pressing arms 306L and 306R are pivotally supported at the rear ends of the arm members 304L and 304R, respectively, with pressing springs 307L and 307R provided at the rear ends of the arm members. The rear pads 308L and 308R are each an abutment member for the back of the user's head, and are pivotally supported on the pressing arms 306L and 306R, respectively. The rear pads 308L and 308R are configured to come in contact with the back of the user's head along the contour of the back of the user's head using the pressing springs 307L and 307R to press the back of the user's head toward the front frame 301.

The above-described configuration of the head-mounting unit 300 is the same configuration as that of the head-mounting unit 200 according to the first embodiment.

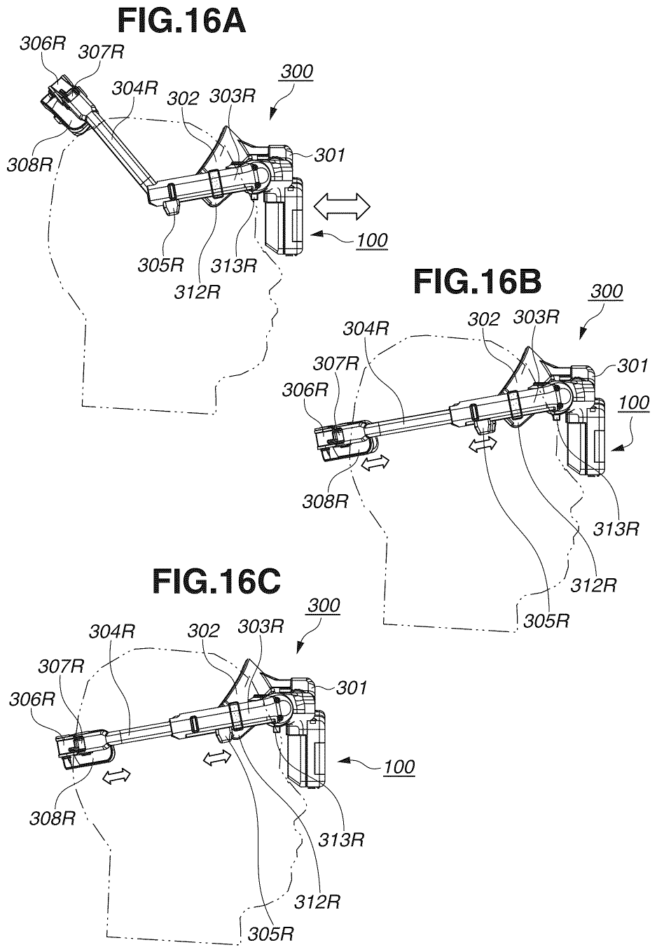

FIGS. 16A to 16C are side views for illustrating procedures 1 to 3 when the head-mounting unit 300 is mounted on the head, with the head-mounting unit 300 viewed from the right. FIG. 16A illustrates the head-mounting unit 300 with the rear pad 308R away from the back of the user's head. FIG. 16B illustrates the head-mounting unit 300 with the rear pad 308R placed closer to the back of the user's head. FIG. 16C illustrates the head-mounting unit 300 with the rear pad 308R in contact with the back of the user's head. When viewed from the left, the head-mounting unit 300 is in states horizontally symmetrical to the states illustrated in FIGS. 16A to 16C.

First, as illustrated in FIG. 16A, by moving the operation levers 305L and 305R backward, the arm members 304L and 304R are extendably moved while sliding backward, i.e., in the longitudinal direction of the side portions 303L and 303R. Upon the ends of the arm members 304L and 304R being moved to the back ends of the side portions 303L and 303R, respectively, the ends of the arm members 304L and 304R become movable in different directions from the longitudinal direction of the side portions 303L and 303R, respectively. Specifically, in the present embodiment, the arm members 304L and 304R become movable upward with respect to the front frame 301. The arm members 304L and 304R are pivoted upward above the head with the ends set as rotational axes to be brought into an opened state. In this manner, with the arm members 304L and 304R in the opened state, the rear pads 308L and 308R are positioned on the upper portion of the user's head. The head-mounting unit 300 can then be brought close to the user's head from the front to bring the front pad 302 into contact with the user's forehead.

Subsequently, as illustrated in FIG. 16B, the operation levers 305L and 305R are moved forward with the front pad 302 in contact with the forehead. At this time, the arm members 304L and 304R are pivoted downward into a shape lined up linearly with the side portions 303L and 303R in the longitudinal direction, respectively. However, the rear pads 308L and 308R do not come in contact with the back of the head at this point of time.

Then, as illustrated in FIG. 16C, by moving the operation levers 305L and 305R further forward, the rear pads 308L and 308R contact the back of the head to press the back of the head via the action of the pressing springs 307L and 307R. In this manner, the head-mounting unit 300 is fixed to the user's head.

In the head-mounting unit 300, the clamping pressure on the user's head can be adjusted as desired by appropriately adjusting the positions of the operation levers 305L and 305R based on the user's head size and the user's preference.

The head-mounting unit 300 can be removed from the user's head by performing operations in the reverse order of the above-described operation procedures (in the order of FIGS. 16C, 16B, and 16A). By moving the operation levers 305L and 305R backward, the arm members 304L and 304R also move backward, resulting in the state where the arm members 304L and 304R are opened upward with respect to the user's head, which allows the head-mounting unit 300 to be removed from the user's head.

The configuration that allows the arm members 304L and 304R according to the present embodiment to be moved vertically is similar to the configuration that allows the arm members 204L and 204R and the inner pieces 209L and 209R according to the first embodiment to be pivotably held. In other words, by the arm members 304L and 304R being pivotably held in the vertical direction using the inner pieces (not illustrated) held integrally with the operation levers 305L and 305R, the vertically movable configuration can be implemented.

Other aspects, such as the provision of a support member serving as a mechanism for holding the positions of the arm members 304L and 304R in the head-mounting unit 300, and the capability of using the HMD according to the present embodiment as an HHD, are the same as those of the head-mounting unit 200 in the first embodiment.

In the present embodiment, as compared with the case in the first embodiment where the arm members extend leftward and rightward, the space used for mounting and removal of the head-mounting unit 300 can be made more compact.

In the above-described manner, according to the present embodiment, the HMD provides increased usability by shortening time used for position adjustment of the side portions 303L and 303R, eliminating unwearability and discomfort when mounted, and facilitating mounting and removal with light force.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-201785, filed Nov. 19, 2024, which is hereby incorporated by reference herein in its entirety.

What is claimed is:

1. A mounting apparatus comprising:
an installation portion configured to allow a video display apparatus to be installed thereon; and
a pair of side portions extending in directions bent from a left end and a right end of the installation portion,
wherein each of the side portions includes an arm member that is movable in a longitudinal direction, and
wherein each of the arm members is movable in a direction different from the longitudinal direction after being extendably moved in the longitudinal direction.

2. The mounting apparatus according to claim 1, wherein each of the arm members is movable outward with respect to the installation portion after being extendably moved in the longitudinal direction.

3. The mounting apparatus according to claim 2, wherein each of the arm members is movable in a leftward or rightward opening direction after being extendably moved in the longitudinal direction.

4. The mounting apparatus according to claim 2, wherein each of the arm members is movable in an upward opening direction after being extendably moved in the longitudinal direction.

5. The mounting apparatus according to claim 1, wherein each of the side portions includes an abutment member disposed at a back end of the corresponding arm member and a pressing member configured to press the abutment member inward with respect to the installation portion.

6. The mounting apparatus according to claim 1,
wherein each of the side portions includes a biasing member at a back end of the corresponding arm member, the biasing member being configured to elastically bias the corresponding arm member outward with respect to the installation portion, and
wherein each of the arm members is movable outward by a biasing force of the biasing member after being extendably moved in the longitudinal direction.

7. The mounting apparatus according to claim 1, wherein each of the arm members is movable in the direction different from the longitudinal direction when a front end of the arm member is moved to a back end of the corresponding side portion, and is guided in the longitudinal direction with the front end received in the corresponding side portion when the front end is contractively moved from the back end of the side portion.

8. The mounting apparatus according to claim 1,
wherein each of the side portions includes an operation member disposed at a front end of the corresponding arm member, and
wherein the corresponding arm member is moved in the longitudinal direction by movement of the operation member in the longitudinal direction.

9. The mounting apparatus according to claim 8, wherein each of the arm members includes a front member at the front end of the arm member, and is pivotally supported on the front member.

10. The mounting apparatus according to claim 9, wherein the front member is provided integrally with the operation member.

11. The mounting apparatus according to claim 8, further comprising a stopping member configured to be detachably attachable at a predetermined fixation position of the corresponding side portion, the stopping member being configured to prevent the corresponding operation member from being moved forward beyond the predetermined fixation position of the corresponding side portion.

12. The mounting apparatus according to claim 11, wherein the stopping member on one side and the stopping member on the other side are configured to be movable in a linked manner.

13. The mounting apparatus according to claim 9,
wherein each of the side portions includes a support member disposed on an outer surface at the back end of the side portion, and
wherein each of the arm members is movable in the direction different from the longitudinal direction with the corresponding front member in contact with the corresponding support member.

14. The mounting apparatus according to claim 13, wherein each of the support members is made of a material having a higher friction coefficient than a friction coefficient of the side portion.

15. The mounting apparatus according to claim 1,
wherein each of the side portions has a cam groove at a back end of the side portion, the cam groove having a backmost end portion bent outward with respect to the installation portion, and
wherein each of the arm members includes a guide pin at a front end of the arm member, the guide pin being movably engageable with the cam groove.

16. The mounting apparatus according to claim 1, wherein each of the side portions is configured to be movable in a direction toward a lower front side together with the corresponding arm member.

17. A video display unit comprising:
a video display apparatus; and
the mounting apparatus according to claim 1.
